(19) United States
(12) Patent Application Publication
(10) Pub. No.: US 2010/0214296 A1
(43) Pub. Date: Aug. 26, 2010

(54) DATA DISPLAY APPARATUS, DATA DISPLAY METHOD AND PROGRAM

(75) Inventor: Kazuhiro KAWAMURA, Sapporo-shi (JP)

Correspondence Address: CANTOR COLBURN, LLP, 20 Church Street, 22nd Floor, Hartford, CT, 06103, US

(73) Assignee: TOKYO ELECTRON LIMITED, Tokyo (JP)

(21) Appl. No.: 12/626,201

(22) Filed: Nov. 25, 2009

Related U.S. Application Data
(63) Continuation-in-part of application No. PCT/JP2008/059534, filed on May 23, 2008.

(30) Foreign Application Priority Data
May 29, 2007 (JP) 2007-141336

(51) Int. Cl. G06T 11/20

(52) U.S. Cl. 345/440

(57) ABSTRACT

A data display apparatus includes a storage, a data retrieving unit, a first display unit, a designation receiver, a display data, and a second display unit. The storage stores time-series data. The data retrieving unit retrieves at least one set of the time-series data from the storage. The first display unit displays the time-series data in a first display width. The designation receiver receives a designation of at least one display subject range. The display data retrieving unit retrieves subset data from the at least one set of the time-series data during at least one period corresponding to the at least one display subject range. The second display unit displays the subset data in a second display width. The first display unit also displays the at least one display subject range in association with the time-series data.

### CROSS-REFERENCE TO RELATED APPLICATION

This is a continuation-in-part application of International Application No. PCT/JP2008/059534, filed on May 23, 2008, which claims priority to Japanese Patent Application No. 2007-141336, filed on May 29, 2007, the contents of which in their entirety are herein incorporated by reference.

### BACKGROUND ART

The present invention relates to a data display apparatus, data display method and program for displaying plural sets of time-series data related to conditions during processing semiconductor.

A method of automatically and accurately processing data sent from a measurement instrument is conventionally known as a method of processing measured data in a group management system having a plural of manufacturing apparatuses processing substrates and a server connected thereto (see, e.g., Japanese Unexamined Patent Publication No. 11-354395). The measured data processing method registers in advance a calculating formula for processing the measured data, stores such measured data in a measured data receiving buffer when receiving the measured data, selects the calculating formula having at least the same recipe name suited for processing the measured data from the registered calculating formula based on the recipe name of the measured data and storing the same in a calculating formula storage buffer, applies the stored measured data to the calculating formula to calculate, and stores the calculation result in a processed data storage buffer.

A conventional group management system has a function displaying time-series data, which are measured in semiconductor manufacturing apparatuses or the like, in chart. The chart includes data from a plural apparatuses managed by the group management system. Such a group management system also has a function of fault detection and classification of abnormalities.

However, such a conventional group management system can not display properly time-series data measured in a semiconductor process or the like. Especially, it is hard to compare plural sets of time-series data.

### DETAILED DESCRIPTION OF THE INVENTION

### Disclosure of the Invention

### Technical Problem

Recently, to control a semiconductor process accurately, it tends to measure at high sampling rate, such as 1 MHz, in a semiconductor manufacturing apparatus. Due to the volume in one set of measured data, it is hard to achieve both of grasping entire trends of data and analyzing data in detail.

### Technical Solution

According to one aspect of the present invention, a data display apparatus includes a storage, a data retrieving unit, a first display unit, a designation receiver, a display data retrieving unit, and a second display unit. The storage stores time-series data. The data retrieving unit retrieves at least one set of the time-series data from the storage. The first display unit displays the time-series data in a first display width. The designation receiver receives a designation of at least one display subject range. The display data retrieving unit retrieves subset data from the at least one set of the time-series data during at least one period corresponding to the at least one display subject range. The second display unit displays the subset data in a second display width. The first display unit also displays the at least one display subject range in association with the time-series data.

According to another aspect of the present invention, a data display method includes retrieving at least one set of time-series data related to conditions during processing semiconductor from a storage and displaying the time-series data in a first display width in association with a time axis. A designation of at least one display subject range is retrieved, which includes at least a part of the time-series data displayed by said first display width. The at least one display subject range is displayed in association with the time-series data. Subset data are retrieved from each set of the time-series data during a period corresponding to the display subject range. The subset data are displayed in a second display width, which is wider than that of the display subject range, in association with a time axis.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 is a conceptual view of a group management system according to a first embodiment of the present invention;

FIG. 2 is a block diagram of the group management system;

FIG. 3 is a view showing one example of a manufacturing apparatus in the group management system;

FIG. 4 is a flowchart describing an operation of a data display apparatus in the group management system;

FIG. 5 is a view showing a display example in the data display apparatus;

FIG. 6 is a view showing a display example in the data display apparatus;

FIG. 7 is a view describing an operation on the data display apparatus;

FIG. 8 is a view describing an operation on the data display apparatus;

FIG. 9 is a view showing a display example in the data display apparatus;

FIG. 10 is a block diagram of a group management system according to a second embodiment of the present invention;

FIG. 11 is a flowchart describing an operation of a data display apparatus in the group management system;

FIG. 12 is a block diagram of a group management system according to a third embodiment of the present invention;

FIG. 13 is a flowchart describing an operation of a data display apparatus in the group management system;

FIG. 14 is a view showing a display example in the data display apparatus;

FIG. 15 is a view showing a display example in the data display apparatus;

FIG. 16 is a view showing a display example in the data display apparatus;

FIG. 17 is a block diagram of a group management system according to a fourth embodiment of the present invention;

FIG. 18 is a flowchart describing an operation of a data display apparatus in the group management system;

FIG. 19 is a view showing an example of a waveform pattern stored in a storage in the a data display apparatus;

FIG. 20 is a view showing an example of a third data stored in the a data display apparatus;

FIG. 21 is a view showing a display example in the data display apparatus;

FIG. 22 is a schematic view showing one example of an outer appearance of a computer system for implementing the data display apparatus according to an embodiment of the present invention; and

FIG. 23 is a view showing one example of a configuration of the computer system.

### EMBODIMENT

### Best Mode for Carrying Out the Invention

Hereinafter, embodiments of the data display apparatus and the like will be described with reference to the drawings. Components denoted with the same reference numeral perform similar operations in the embodiments, and thus redundant description may not be given.

### First Embodiment

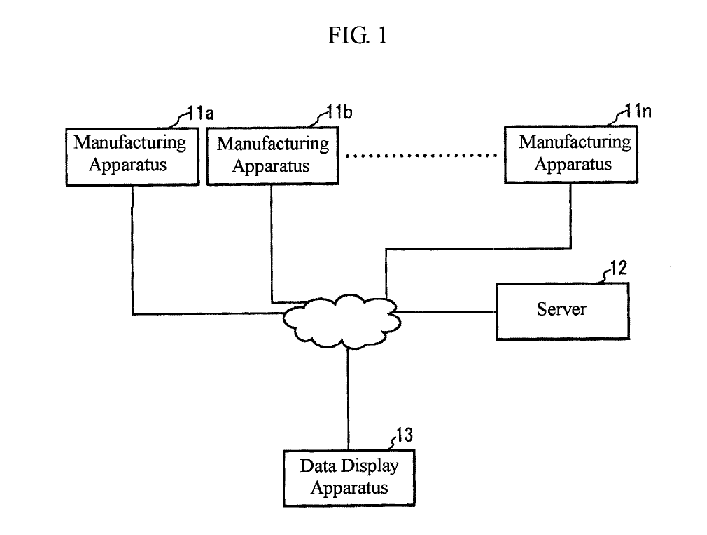

FIG. 1 is a schematic diagram showing an example of a group management system according to the present embodiment. The group management system has N of manufacturing apparatuses 11, a server 12, and a data display apparatus 13. Here, N refers to an integer of 1 or more.

The manufacturing apparatus 11, the server 12 and the data display apparatus 13 can send/receive information to/from each other. Information can be sent/received via any kind of connection, for example, a network, such as internet, wired or wireless LAN or Wi-Fi, a short-range radio communication protocol, such as Bluetooth™, or bus connection, such as USB or IEEE1394. Besides, the way to send/receive can be communication or broadcasting.

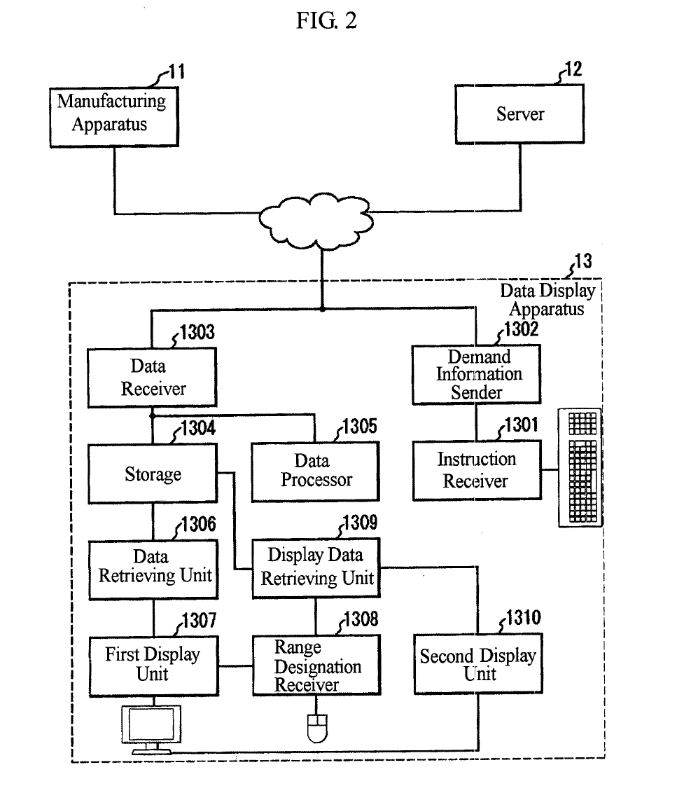

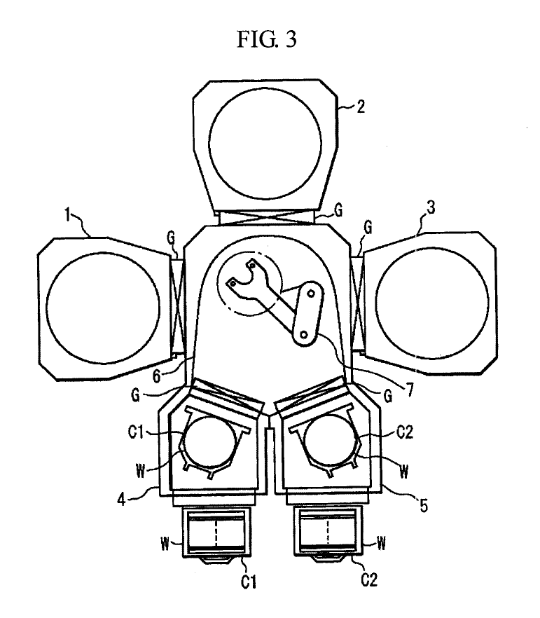

FIG. 2 is a block diagram showing an example of a group management system according to the present embodiment. To make explanation simple and clear, FIG. 2 shows a group management system having only one manufacturing apparatus 11 as an example.

The manufacturing apparatus 11 is, for example, a semiconductor manufacturing apparatus or a flat panel display manufacturing apparatus. Those apparatuses conduct processes, such as deposition, etching or thermal oxidation, on semiconductor wafers, liquid crystal display substrates, plasma display panel substrates or the like.

FIG. 3 shows a semiconductor manufacturing apparatus as one example of the manufacturing apparatus 11. The semiconductor manufacturing apparatus in FIG. 3 has three process chambers 1, 2, 3, two cassette chambers 4, 5, and transfer chamber 6 therebetween. The transfer chamber 6 and the other chambers are connected by way of a gate valves G in a freely opening and closing manners. The process chambers 1, 2, 3 conduct various kinds of processes, such as deposition, etching, or thermal oxidation. The cassette chambers 4, 5 hold cassettes C1, C2 respectively. The cassettes C1, C2 hold, for example, fifty wafers W in each. The transfer chamber 6 has a stretchable-rotatable transfer arm 7 therein, which transfer wafers among the process chambers 1, 2, 3 and the cassette chambers 4, 5. The cassettes C1, C2 are loaded in the cassette chambers 4, 5, turned by 90 degree, rotated to face their access-opening to the center of the transfer chamber 6, and set to the position where the transfer arm 7 can access wafers W in the cassettes C1, C2.

The manufacturing apparatus 11 stores recipes, which are information determining processes for wafers. The manufacturing apparatus 11 uses the recipes to control manufacturing processes. A recipe is usually a set of process condition values or the like.

The manufacturing apparatus 11 collects one or more sets of time-series data related to states therein, and sends the data to the server 12. Here, the time-series data related to the state is data related to the operation state of the manufacturing apparatus or data related to the process state, which are acquired in chronological order. The data related to the operation state include data indicating what kind of process or control which a manufacturing apparatus has begun or is executing, data indicating variation of control value during control of the manufacturing apparatus, or the like. The data related to the process state include data measured during a semiconductor process: temperature or pressure in the manufacturing apparatus, power or flow rate of process gas supplied to the manufacturing apparatus, or the like. The measured data are acquired with one or more temperature sensors, one or more vibration sensors, one or more flow rate sensors, or the like. The manufacturing apparatus 11 usually output the state data in association with time data, which correspond to when the state data are constructed or the data constructing the state data are collected. The time data also may correspond to when the server 12 receives state data. The state data may also related to the category information of the measured data, such as “Temperature” or “Pressure.” Each manufacturing apparatus 11 usually sends plural sets of the state data in different categories. However, a plural of manufacturing apparatus may send data in one category. Identification information may be added to state data for indentifying the manufacturing apparatus 11 that sends the state data, especially when a plural of manufacturing apparatuses are operated.

To process a semiconductor wafer and to collect and send the state data, several ways publicly known can be applied.

The server 12 is one of the elements constructing the group management system. It receives and stores plural sets of the time-series state data, which are sent from one or more manufacturing apparatuses 11. It also sends the stored state data to the data display apparatus 13, responding to demand information sent from the data display apparatus 13. The demand information may include the information to identify a subject apparatus of which the state data are demanded or the information specifying the time range where the state data are demanded to be sent, such as start and end times or a start time and a time length. In such a case, the server 12 retrieves the state data corresponding to the demand information, which specifies the subject apparatus and the time range from storage and sends the same to the data display apparatus 13 that requires the state data. However, the server 12 may send the state data to the pre-specified data display apparatus 13 in pre-specified periodic or aperiodic timing regardless of the demand information. The server 12 may also derive a new set of state data from the stored state data. For the server 12 to receive, store or send state data in group management system of semiconductor manufacturing apparatuses, several ways publicly known can be applied.

The data display apparatus 13 has an instruction receiver 1301, a demand information sender 1302, a data receiver 1303, a storage 1304, a data processor 1305, a data retrieving unit 1306, a first display unit 1307, a range designation receiver 1308, a display data retrieving unit 1309, and a second display unit 1310.

The instruction receiver 1301 receives an instruction to send demand information demanding plural sets of the state data, which are stored in the server 12. The instruction received by the instruction receiver 1301 may include information to specify a category of state data, a time range of state data, such as start and end times or a start time and a time length. It may also include information to specify the subject manufacturing apparatus 11, such as identification information. The instruction is input by an input device or sent from other devices. The input device is, for instance, a numeric keypad, a keyboard, a mouse, touch-screen. The instruction receiver 1301 can be implemented by a device driver for those input devices or control software for a menu screen.

The demand information sender 1302 constructs demand information corresponding to instruction received by the instruction receiver 1301 and sends the same to the server 12. The demand information includes, in particular, information demanding to send the state data corresponding to information specifying a category and a time range of state data and a subject manufacturing apparatus 11, and the like. The demand information sender 1302 can be implemented by a device or software for wired or wireless communication.

However, if the server 12 sends pre-specified state data to a pre-specified data display apparatus 13 regardless of demand information, the server 12 need not to have the instruction receiver 1301 and the demand information sender 1302.

The data receiver 1303 receives the state data and stores the same to the storage 1304. The data receiver 1303 can be implemented by a device or software for wired or wireless communication.

The storage 1304 can store plural sets of the time-series data during a semiconductor process. The time-series data include process data or state data, in particular, received by the data receiver 1303 or processed by the data processor 1305 after received. For instance, the storage 1304 stores the time-series data measured in the manufacturing apparatus 11 periodically. The storage 1304 may store data temporally or permanently. In other words, it can be either a volatile recording medium or a non-volatile one.

The data processor 1305 processes the time-series data received by the data receiver 1303 and constructs a new set of time-series data. It can process data in any kinds of ways, for example, wavelet transform, normalize or regularize. The process may be predetermined or instructed via an instruction device. The data processor 1305 may process directly the time-series data received by the data receiver 1303 or the time-series data retrieved from the storage 1304 after stored by the data receiver 1303. The data processor 1305 is usually implemented with a micro processor unit, a memory and other peripheral devices. Though process procedures in the data processor 1305 are usually implemented with software, which is stored in recording medium such as a read only memory, it also can be done with hardware, or dedicated circuit.

However, if it is unnecessary to construct a new set of time-series data from the time-series data, the data processor 1305 is not needed.

The data retrieving unit 1306 retrieves one or more sets of the time-series data from the storage 1304. The data retrieving unit 1306 may retrieve the time-series data stored in the storage 1304 either entirely or a partially. The range may be either predetermined or determined by information, such as start and end time or start time and needed time length, specified with the instruction receiver 1301 or other devices. In case that the range is not determined, the data retrieving unit 1306 may retrieve the time-series data stored in the storage 1304 entirely. If the time-series data do not exist in the specified range, “0” can be padded for indicating that there are no time-series data there.

The data retrieving unit 1306 may also retrieve a single set or all sets of the time-series data. The retrieved time-series data are can be specified in any ways. For instance, the retrieved time-series data may be either predetermined or specified using information about a data category or apparatus identification information by users with an instruction device. The data retrieving unit 1306 is usually implemented with a micro processor unit, a memory and other peripheral devices. Though process procedures in the data retrieving unit 1306 are usually implemented with software, which are stored in a recording medium, such as a read only memory, it also can be done with hardware or dedicated circuit.

The first display unit 1307 displays one or more sets of the time-series data retrieved by the data retrieving unit 1306 in a first display width in association with a time axis. Displaying in association with a time axis means, in particular, drawing data in a graph whose longitude or latitude axis is a time axis. Displaying in a first display width means displaying time-series data as their start and end data are located at both end of the first display width in direction of a time axis respectively. The first display width may be either fixed or changed upon instruction from an instruction device. Depending on the first display width, the first display unit 1307 may resample the time-series data to fit the width and to display smoothly. It can be determined in any ways which set of time-series data is displayed. When plural sets of the time-series data are displayed, they may be overlapped each other.

The first display unit 1307 displays the information indicating the display subject range received by the range designation receiver 1308, which will be described later, to the time-series data. Displaying data in association with the time-series data means displaying the display subject range in a way that the location thereof can be recognized uniquely in the time-series data displayed by the first display unit 1307. More specifically, the display subject range is displayed distinct from the other range in the time-series data displayed by the first display unit 1307. In particular, an image indicating the display subject range is superimposed on the time-series data or displayed along the time axis. The image indicating the display subject range is, for instance, an object image, which colors the range by overlay, highlight the range, or encloses or separates the range by dotted or border line. Here, the range means, in particular, a period of time. To display the display subject range, several ways publicly known, such as displaying the range selected by an instructing device, can be applied. The first display unit 1307 may include a display device or output to an external one. It can be implemented with a device driver for a display device, or with a device driver and a display device.

The range designation receiver 1308 receives the designation of the display subject range, which is a part of the time-series data displayed by the first display unit 1307. The display subject range is information, at least, which can identify start and end points along the time axis. In view of an intuitive operation, it is preferable that the range designation receiver 1308 receives the designation of the display subject range specified by a pointing device, such as a mouse device. In particular, the designation of range can be specified by operating a pointing device to trace or to drag on or adjacent to the time-series data displayed by the first display unit 1307. When the display subject range is already displayed on or adjacent to the time-series data, the range can be changed by operating a pointing device. For instance, when a rectangular object image indicating the display subject range is superimposed on time-series data displayed by the first display unit 1307, the display subject range can be moved by dragging the center of the object image with a pointing device. The display subject range also can be changed by dragging either ends of the rectangular object image. The display subject range also can be changed by any other ways. For instance, it can be done by receiving values, such as start and end times, which are received from an instruction device or sent from other devices. The input device can be any device, such as a numeric keypad, a keyboard, a mouse or a touch screen. The range designation receiver 1308 can be implemented with a device driver for a numeric keypad, a keyboard or the like, or software controlling a menu screen.

The display data retrieving unit 1309 retrieves the time-series data corresponding to the display subject range received by the range designation receiver 1308. In particular, the display data retrieving unit 1309 retrieves the start and end times of the display period corresponding to the display subject range and plural sets of the time-series data between the start and end times. It can be done in any ways to specify which sets of time-series data are loaded. It can be specified with an input device or be predetermined. The start and end times corresponding to the display subject range received by designation receiver 1308 can be calculated from the positions of both end of the display subject range superimposed on the time-series data and the times of both end of the time-series data, using the ratio therebetween or the like. The start and end times corresponding to the display subject range can be also calculated from the distances between both ends of the displayed time-series data and the both ends of the display subject range, using the pre-calculated relationship between a displayed distance and a time on the time-series data from the first display width and the period of the time-series data displayed by the first display unit 1307. If the time-series data do not exist in a part of or all of display subject range, the display data retrieving unit 1309 may skip the period where no time-series data exist or retrieve a predetermined numeral, such as “0”, as data in such a period. The display data retrieving unit 1309 is usually implemented with a micro processor unit, a memory and other devices. Though process procedures in the display data retrieving unit 1309 are usually implemented with software, which are stored in recording medium, such as a read only memory, it also can be done with hardware, or a dedicated circuit.

The second display unit 1310 displays plural sets of the time-series data in the display period retrieved by the display data retrieving unit 1309 in association with a time axis in a second display width, which is broader than the display subject range. Though the second display width is usually comparable to the first one, it may be different. In the case that the former is narrower than the latter, to make sure that the second display width is wider than the display subject range, the maximum width of the display subject range may be set narrower than the second display width. The second display width may be fixed or changed by instruction with an input device. Depending on the second display width, the second display unit 1310 may resample process-related data to fit the width or to display smoothly. It can be determined in any ways which sets of time-series data are displayed. To display plural sets of the time-series data, each time-series data is usually displayed individually in association with a time axis in the second display width. However, plural sets of the stated data may be partly overlapped each other. When the display subject range is not specified, the second display unit 1310 may display each entire time-series data individually in the second display width.

The second display unit 1310 may include a display device or output to an external one. It can be implemented with a device driver for a display device, or with a device driver and a display device or the like.

Since it is possible to update display of the second display unit 1310 in response to a designation of the display subject range, it is preferable that receiving of the range designation receiver 1308 triggers a series of processes that the display data retrieving unit 1309 retrieves the time-series data corresponding to the range and the second display unit 1301 displays the data.

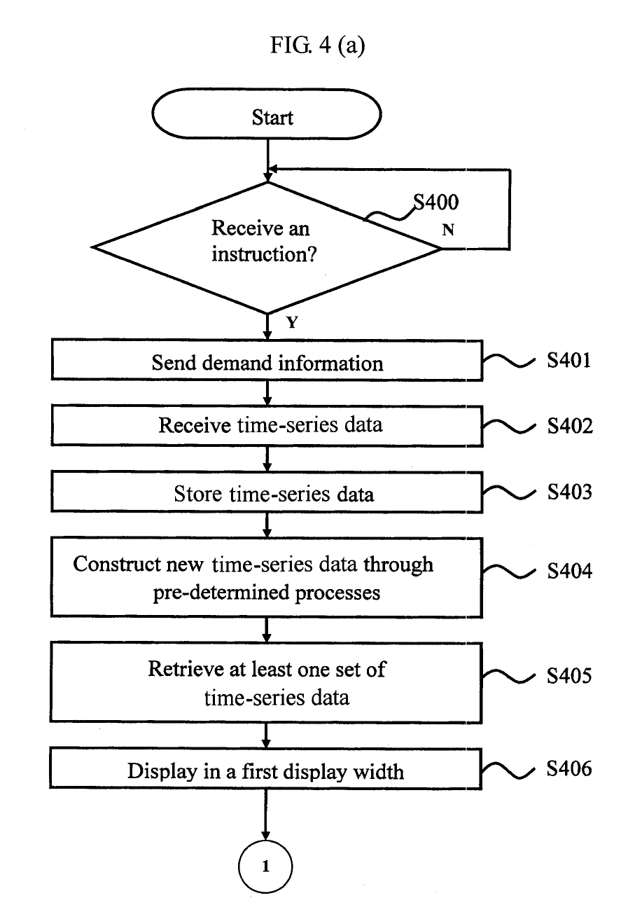

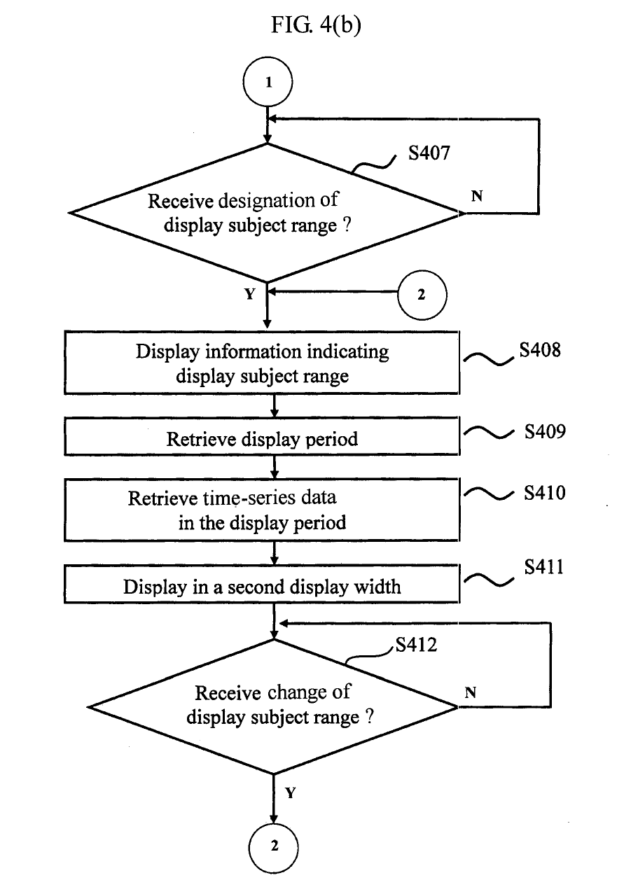

Following is an explanation of the operation in the data display apparatus 13 with reference to the flow chart drawn in FIG. 4. In one example, the instruction receiver 1301 receives information specifying a period and a category of the time-series data for obtaining one or more sets of the time-series data from the server 12.

(Step S400) The instruction receiver 1301 determines whether it has received an instruction to send demand information. If it has received, the process proceeds to step S401; otherwise, returns to step S400.

(Step S401) The demand information sender 1302 constructs demand information corresponding to the instruction received by the instruction receiver 1301 and sends the demand information to the server 12. Corresponding to the instruction, for instance, the demand information sender sends demand information demanding that the server 12 send intended time-series data in an intended period.

(Step S402) The data receiver 1303 receives the time-series data sent by the server 12.

(Step S403) The data receiver 1303 stores the time-series data received in step S402 into the storage 1304

(Step S404) The data processor 1305 constructs a new set of data through processing the time-series data that are received by the data receiver 1303 or retrieved from the storage 1304. After that, the constructed data is stored into the storage 1304. In the present example, the time-series data processed by the data processor 1305 are pre-specified and the processes for them are also pre-determined.

The data retrieving unit 1306 retrieves the time-series data from the storage 1304. In the present example, it retrieves the entire period of the time-series data received in step S402.

(Step S406) The first display unit 1307 displays the time-series data retrieved by the data retrieving unit 1306 in a first display width in association with a time-axis.

(Step S407) The range designation receiver 1308 determines whether it has received a designation of a display subject range, which is a part of range within the time-series data displayed by the first display unit 1307. If it has received the designation, the process proceeds to step S408; otherwise, returns to step S407.

(Step S408) The first display unit 1307 displays information indicating the display subject range received in step S407 in association with the time-series data displayed in step 406. For instance, it superimposes the range onto the time-series data.

(Step S409) The display data retrieving unit 1309 retrieves the information indicating an actual display period corresponding to the display subject range received in step S407. In particular, the start and end times of the display period are derived from the times and the coordinates corresponding to the both ends of the state information displayed by the first display unit 1307 in the first display width and the coordinates corresponding to the both ends of the display subject range received by the range designation receiver 1308.

(Step S410) The display data retrieving unit 1309 retrieves data in the display period derived in step S409 from the time-series data stored in the storage 1304. In the present example, it is pre-specified the category of time-series data from which the display data retrieving unit 1309 retrieves.

(Step S411) The second display unit 1310 displays the time-series data retrieved in step S410 in a second display width in association with a time axis. In the present example, the second display width is pre-specified.

(Step S412) The range designation receiver 1308 determines whether it has received a change of display subject range. If it has received the change, the process proceeds to step S408; otherwise, returns to step S412.

In the flow chart of FIG. 4, the series of processes end by power off or interrupt of termination.

Several ways publicly known can be applied to the operation of the manufacturing apparatus 11 and the server 12.

Following is a detailed example of an operation in one embodiment of a group management system with the data display apparatus 13. FIG. 1 is a schematic diagram of an example of the group management system.

In this example, time-series data are sent from the manufacturing apparatus 11 to the server 12 in association with time data starting from 0, which indicate the start time of measurement. The time-series data are measured periodically at 1 MHz of sampling rate on temperature, vibration or flow rate of gas during operation of the manufacturing apparatus 11.

The sent data are stored in the server 12 in association with the time data.

The instruction receiver 1301 receives an instruction via a input device, such as a keyboard, to retrieve first and second sets of time-series data from 3000×10⁻⁶ sec to 7000×10⁻⁶ sec out of plural sets of time-series data stored in the server 12. The first and second sets of time-series data can be any kinds of measured data. To simplify the explanation, the first and second sets of time-series data have a same measurement unit in the present example.

In response to the instruction, the demand information sender 1302 sends the server 12 a demand signal demanding the first and second sets of data from 3000×10⁻⁶ sec to 7000×10⁻⁶ sec.

The server 12 retrieves and sends the data corresponding to the demand signal to the data display apparatus 13.

The data receiver 1303 receives the data and stores them into the storage 1304.

In the present example, based on pre-designation to display the data derived via wavelet transform of the first and second sets of time-series data with the first and second sets of time-series data, the data processor 1305 wavelet-transforms the first and second sets of time-series data retrieved from the storage 1304. The data wavelet-transformed are stored in the storage 1304. To wavelet-transform, any ways known publicly can be used.

To display the time-series data, the data retrieving unit 1306 loads them from the storage 1304. In the present example, it is pre-specified that the data retrieving unit 1306 retrieves the entire period of data received by the data receiver 1303 and the first display unit 1307 displays the entire period of the first and second sets of time-series data.

The first display unit 1307 constructs a graph where the first and second sets of time-series data are overlapped each other and plotted along time axis in a first display width, and display the graph on a display device. In the present example, the first display width is pre-specified, for example, 400 pixels. The height of the graph is 160 pixels. The unit of time axis is 10⁻⁶ sec. Because the numbers of the first and second sets of time-series data are much more than that of pixels in the first display width, the data are re-sampled before displayed.

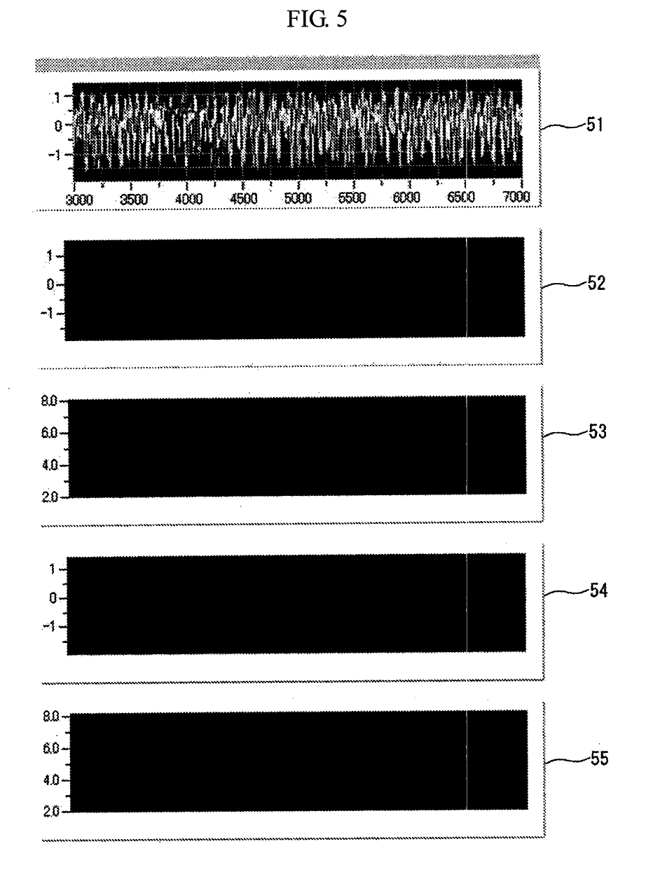

FIG. 5 shows a sample of graph constructed by the first display unit 1307. The first and second sets of time-series data are overlapped each other and displayed in a graph 51 that is an only graph displayed by the first display unit 1307. The horizontal and vertical axes indicate time and value of time-series data respectively. Graphs 52 to 55, which are not displayed at this point, are displayed by the second display unit 1310. In the present example, the first and second display units 1307, 1310 display on a same display device.

The range designation receiver 1308 receives a designation of display subject range that is a part of range in the graph 51. The range is selected by user through moving a pointer on the display device with a mouse. In particular, the range designation receiver 1308 receives the values of x coordinate selected with the mouse. In the present example, to simplify explanation, the x coordinates of left and right ends of the graph 51 are “0” and “400” respectively. If the x coordinates of left and right ends of the range selected by a user are “160” and “280”, the designation receiver 1308 receives “x=160” and “x=280” as the display subject range.

The first display unit 1307 changes a background color in the selected range in the graph 51 based on those coordinate values.

The display data retrieving unit 1309 retrieves the period information corresponding to the display subject range from those coordinate values. In particular, the range of time axis of the graph 51 is the period from 3000×10⁻⁶ sec to 7000×10⁻⁶ sec and displayed in 400 pixels. The display data retrieving unit calculates (7000−3000)×10⁻⁶ sec/400 pixels and obtains that 1 pixel in the graph 51 is corresponding to 10×10⁻⁶ sec. Then, it calculates the times of left and right ends of the display subject range, i.e. (3000+160×10)×10⁻⁶ sec and (3000+280×10)×10⁻⁶ sec. Therefore, the period corresponding to the display subject range is the period from 4600×10⁻⁶ sec and 5800×10⁻⁶ sec. The display data retrieving unit 1309 retrieves, from the storage 1304, the first and second sets of time-series data and the data constructed therefrom through wavelet transform in the period. It constructs and displays graphs of those data, having the second display width, along a time axis in a way similar to the first display unit 1307. In the present example, the second width is pre-designated and almost same size to the first display width, such as 410 pixels. The display data retrieving unit 1309 re-samples those data to fit to each display width before display.

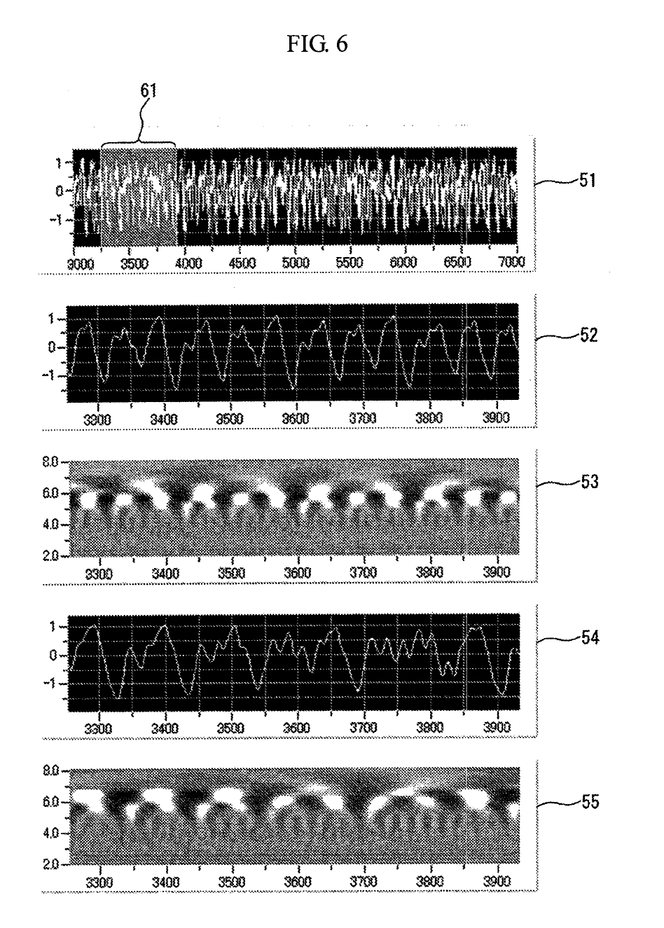

FIG. 6 shows a sample set of graphs constructed by the first and second display units 1307, 1310. As in FIG. 5, the graph 51 is displayed by the first display unit 1307, and the graphs 52 to 55 are displayed by the second display unit 1310. In particular, the graphs 52,54 show the first and second time-series data, and the graph 53, 55 show data constructed therefrom through wavelet transform, respectively.

As shown in FIG. 6, the first display unit 1307 displays the entire periods of the first and second time-series data and the range received by the range designation receiver 1308 as a region 61 having a background color different from other regions in the graph. The second display unit 1310 shows the data corresponding to the region 61 in the second display width, which is wider than the region 61 and is almost similar to the first display width.

By displaying as above, it is possible to zoom information which are time-series data corresponding to the range specified by a user on a graph displayed by the first display unit 1307 and/or the data constructed therefrom through wavelet transform. Thus a user can see and analyze data in detail. It is also possible to display the entire time-series data, the zoomed data and the range where the latter correspond in the former, simultaneously. Thus a user can grasp visually and instantly a range where data displayed by the second display unit 1310 corresponds in entire time-series data displayed by the first display unit 1307. Recently, progress of hardware makes possible to measure a state during a semiconductor process more frequently and to zoom measured data in detail. According to the present embodiment, a user can choose range and observe data there in detail, intuitively and effectively while observing entire data.

The second display unit 1310 displays plural sets of time-series data corresponding to the same display subject range received by the range designation receiver 1308. It allows a user to compare plural sets of stated data easily because those have a same range.

It is possible to specify a display subject range on a graph displayed by the first display unit 1310. Thus a user can operate and choose a range to zoom easily.

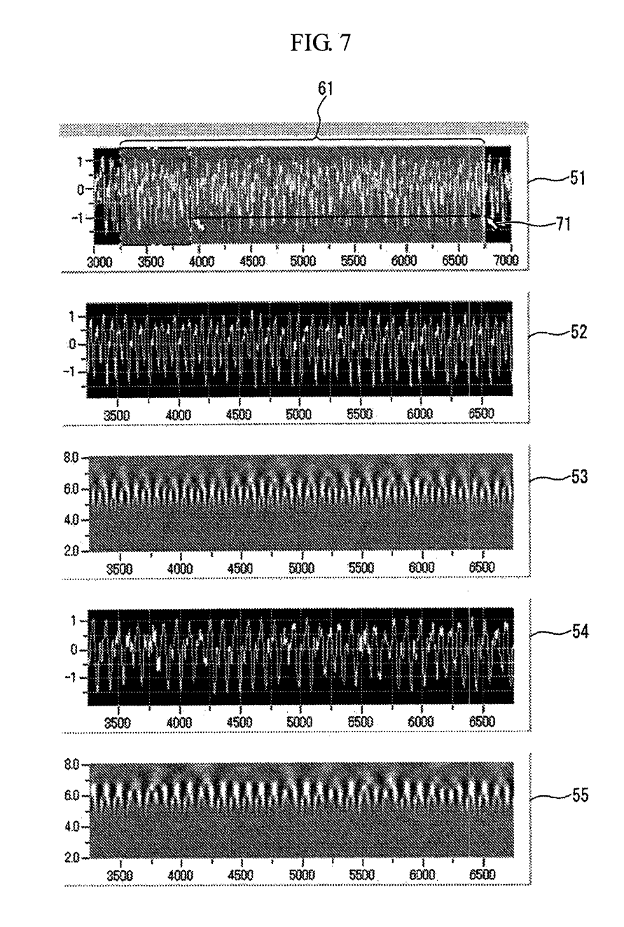

When a user moves a pointer 71 by dragging the end in time axis direction of the region 61, which shows the display subject range displayed by the first display unit 1307, with a mouse, as shown in FIG. 7, the range designation receiver 1308 receives the changed display subject range having new width. This operation changes the width of the region 61 displayed by the first display unit 1307 and the period where the display data retrieving unit 1309 retrieves data. Thus, the second display unit 1310 displays the data corresponding to the changed region 61.

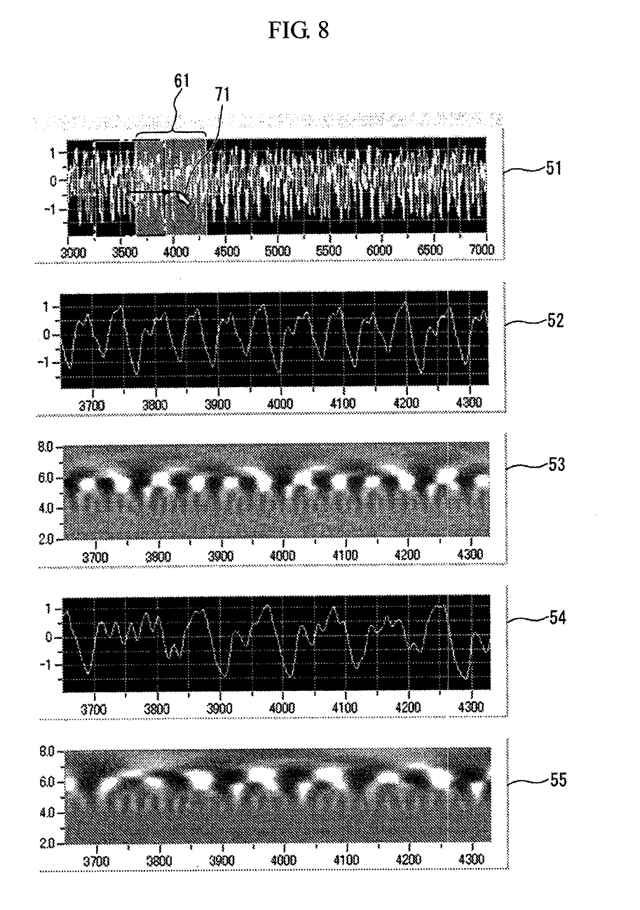

When a user moves the pointer 71 by dragging the center area of the region 61 with a mouse, as shown in FIG. 8, the range designation receiver 1308 receives the display subject range changed along a time axis. This operation changes the location of the region 61 displayed by the first display unit 1307 and the time period where the display data retrieving unit 1309 loads data. Thus the second display unit 1310 displays data corresponding to the changed region 61.

It is possible to change the width and location of the display subject range on a graph displayed by the first display unit as described above. Thus, a user can operate and change a range to zoom easily.

According to the present embodiment, the first display unit 1307 displays one or more sets of time-series data related to the manufacturing apparatus 11, and the second display unit zooms plural sets of time-series data, simultaneously. Thus, a user can see and analyze time-series data related to semiconductor process in detail. It is also possible to display the entire time-series data, the zoomed data and the range where the zoomed data correspond in the entire time-series data simultaneously. Thus, a user can grasp visually and instantly a range where data displayed by the second display unit 1310 corresponds in the entire time-series data displayed by the first display unit 1307.

The second display unit 1310 displays plural sets of data corresponding to the same display subject range received by the range designation receiver 1308. It allows a user to compare plural sets of time-series data easily because those have a same range.

In the present embodiment, anything can be a timing or a trigger for that the data processor 1305 constructs a new set of time-series data by processing time-series data. For instance, when the range designation receiver 1308 receives a designation of a display subject range, the data processor 1305 constructs a new set of time-series data through wavelet transform of the time-series data in the display subject range stored in the storage 1304 and output the constructed data to the display data retrieving unit 1309.

In another example of the present embodiment, a data processor, similar to the data processor 1305, in the server 12 may construct a new set of time-series data from the time-series data stored in the server 12 and send the time-series data and the data constructed therefrom to the data display apparatus 13.

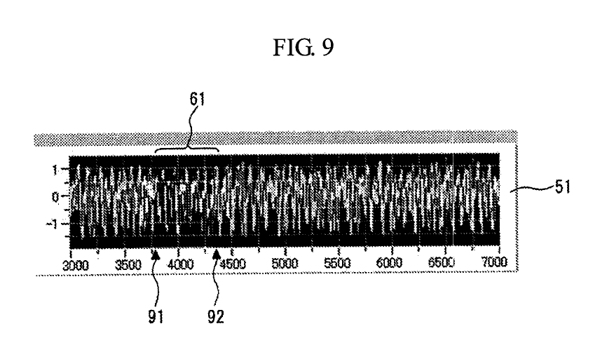

It can be any ways to display the display subject range. In FIG. 9, for instance, markers 91, 92, corresponding to the start and end times of the display subject range respectively, are displayed both end of the region 61 on graph 51.

### Second Embodiment

In another embodiment, it is different from the first embodiment that a data processor processes time-series data between retrieved by a display data retrieving unit and displayed by a second display unit.

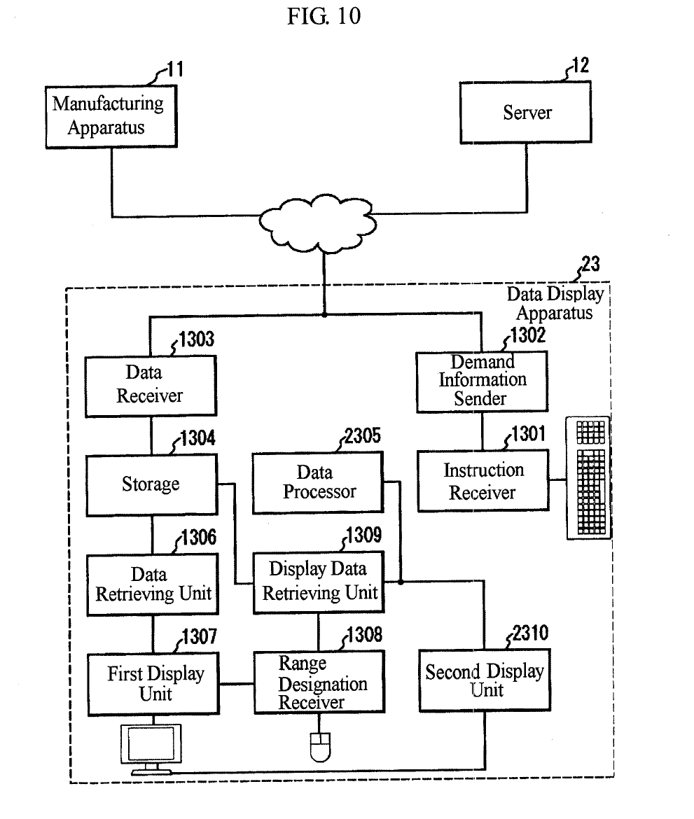

FIG. 10 is a block diagram showing an example of a group management system having a data display apparatus according to the present embodiment. The units having the numbers same with the ones in FIG. 2 are same or equivalent.

A data display apparatus 23 has a instruction receiver 1301, a demand information sender 1302, a data receiver 1303, a storage 1304, a data processor 2305, a data retrieving unit 1306, a first display unit 1307, a range designation receiver 1308, a display data retrieving unit 1309, and a second display unit 2310.

In the data display apparatus 23, the configuration is similar to the first embodiment, except for the data processor 2305 and the second display unit 2310.

The data processor 2305 processes one or more sets of time-series data retrieved by the data retrieving unit 1309, and outputs the processed data to the second display unit 2310. It may process data in any ways, such as wavelet transform or regularization. Regularization is to reduce influence out of difference of data unit or category. What kind of process it conducts may be pre-determined or instructed with an input device. It may process any sets of time-series data, which are retrieved by the display data retrieving unit 1309. Which set of data is processed is specified by a user with an input device, default setting, or any other ways. It also may process all sets of time-series data, which are retrieved by the display data retrieving unit 1309. The data processor 2305 is usually implemented with a micro processor unit, memory and other peripheral devices. Though process procedures of the data processor 2305 are usually implemented with software, which are stored in a recording medium, such as a read only memory, it also can be done with hardware, or a dedicated circuit.

The second display unit 2310 displays the time-series data retrieved by the display data retrieving unit 1309 or processed by the data processor 2305 in association with a time axis in a second display width, which is broader than the display subject range. Plural sets of time-series data may be overlapped each other or displayed in different graphs, or in different areas such as windows. The rest of configurations and operations of displaying time-series data in the second width are similar to the first embodiment.

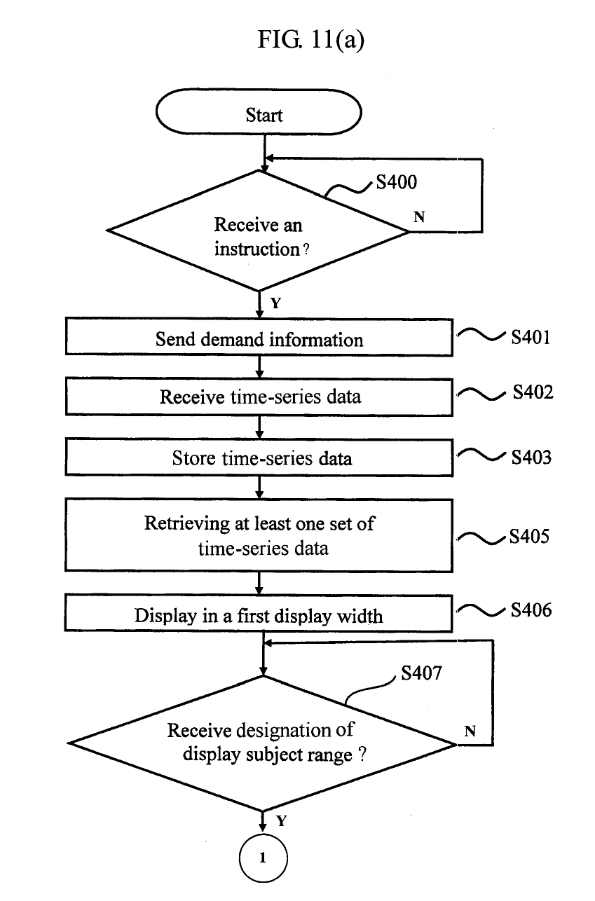

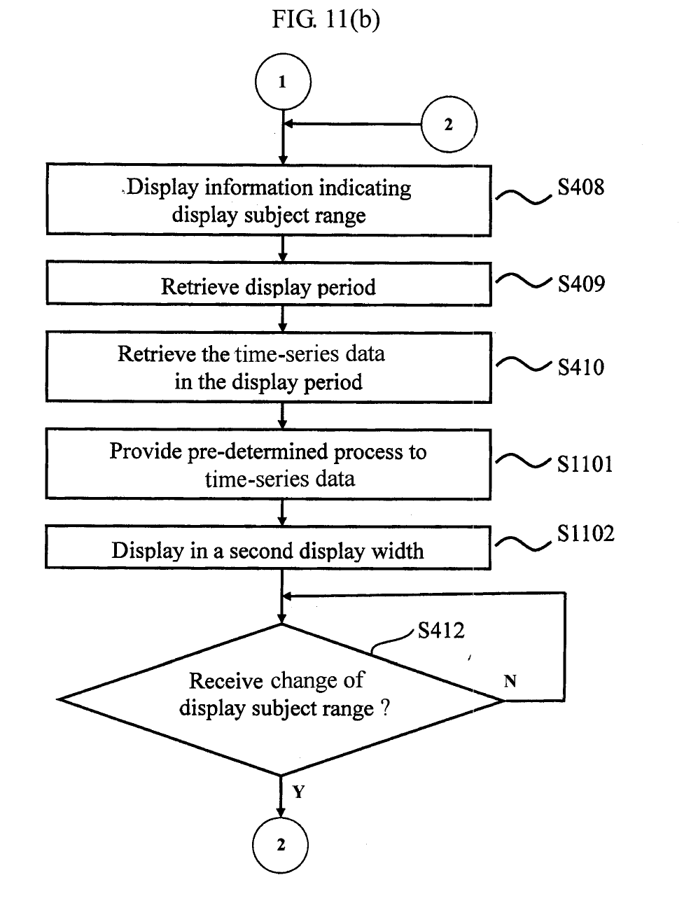

Following is an explanation of an embodiment of operation in the data display apparatus 23 with reference to the flow chart drawn in FIG. 11. The steps having the numbers same with the ones in FIG. 4 are same or equivalent. The only steps different from FIG. 4 will be explained below.

(Step S1101) The data processor 2305 processes the time-series data retrieved in step S410.

(Step S1102) The second display unit 2301 displays time-series data retrieved in step S410 or processed in step S1101 in association with a time axis in a second display width.

Following is a detailed example of operation of the group management system with the data display apparatus 23 according to the present embodiment. The schematic diagram of the present example of the group management system is similar to FIG. 1.

In this example, similar to the example explained in first embodiment, the data receiver 1303 receives a first and second sets of measured data as time-series data, and the first display unit 1307 displays a graph 51 showing them, which are overlapped each other, along time axis, as shown in FIG. 5.

A user moves a pointer on a display device with a mouse and choose a part of range in the graph 51 displayed by the first display unit 1307. The range designation receiver 1308 receives the part of range specified by a user as a display subject range.

The display data retrieving unit 1309 retrieves the display subject range and the first and second sets of time-series data in the range.

In the present example, the data processor processes both sets of the retrieved data with wavelet transform.

The second display unit 2310 plots each set of the processed data and retrieved data on different graphs whose widths are same with the first display width, respectively. The display result is similar to the example in the first embodiment, as shown in FIG. 6. The graphs 52, 54 show the first and second sets of time-series data retrieved by the display data retrieving unit 1309, while the graphs 53, 55 show the wavelet-transformed thereof.

The configurations and operations of changing a display in synchronization with a change of a display subject range are similar to the detailed embodiment in the first embodiment.

According to the present embodiment, in addition to the effect of the first embodiment, the amount of data processed in the data processor 2305 can be reduced because it processes the data only in the display subject range. Besides, it is possible to display the time-series data processed on real-time when displaying data.

### Third Embodiment

In yet another embodiment, a data display apparatus is configured to be able to choose a plural of display subject ranges in one set of displayed time-series data, and displays the data in the period corresponding to each range in a second display width.

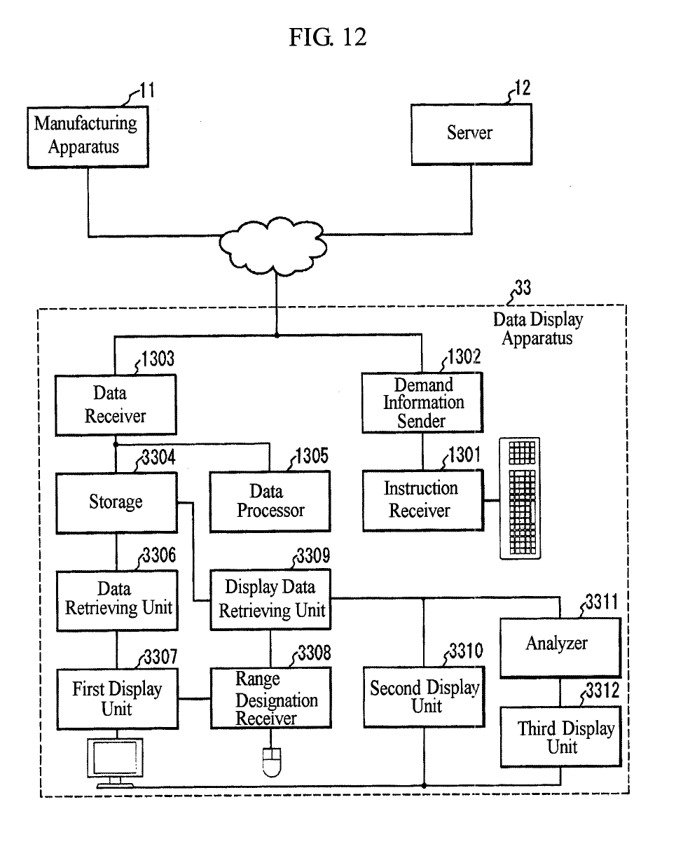

FIG. 12 is a block diagram showing an example of the group management system having a data display apparatus according to the present embodiment. The units having numbers same with the ones in FIG. 2 are same or equivalent.

A data display apparatus 33 has a instruction receiver 1301, a demand information sender 1302, a data receiver 1303, a storage 3304, a data processor 1305, data retrieving unit 3306, a first display unit 3307, a range designation receiver 3308, a display data retrieving unit 3309, a second display unit 3310, an analyzer 3311, and a third display unit 3312.

In the data display apparatus 33, the configurations of the instruction receiver 1301, the demand information sender 1302, data receiver and the data processor 1305 are similar to the first embodiment.

The storage 3304 stores time-series data, which are time-series data measured during a semiconductor process. Except it stores one set of time-series data, the configuration is similar to the first embodiment.

The data retrieving unit 3306 retrieves one set of time-series data from the storage 3304. Except it retrieves one set of time-series data, the configuration is similar to the first embodiment.

The first display unit 3307 displays one set of time-series data retrieved by the data retrieving unit 3306 in association with a time axis in a first display width. The first display unit 1307 also displays a display subject range, which is received by the range designation receiver 3308, in association with the time-series data and displays them. The configuration to display a display subject range is similar to the first embodiment.

Following is an explanation of an example that the first display unit 3307 displays one set of time-series data plurally, in other words, in a plural of graphs or windows in the first display width. All of the graphs or windows, of course, do not have to have a same width. The first display unit 3307 displays one set of time-series data in n of graphs arrayed in a way of having a same period. Here, n is an integer more than one. The first display unit 3307 displays each of the display subject range received by the range designation receiver 3308 in association with each set of the time-series data displayed by the first display unit 3307, where those ranges are specified. In particular, when the range designation receiver 3308 receives a display subject range in the k-th graph, which is one of the graphs in which the first display unit 3307 displays same one set of time-series data, the first display unit 3307 displays the range in association with the k-th graph. Here, k is an integer from 1 to n.

However, the first display unit 3307 may display one set of time-series data in one graph or window. In this case, a plural of display subject ranges are displayed in association with the one graph or window. The rest of configuration of the first display unit 3307 is similar to the first embodiment.

The range designation receiver 3308 receives designation of a plural of display subject ranges in the one set of time-series data displayed by the first display unit 3307. In particular, when the first display unit 3307 displays the one set of time-series data in a plural of graphs, the range designation receiver 3308 receives each display subject range in each graph. It is preferable that those range are different from each other. If the first display unit 3307 displays one set of time-series data in one graph, a plural of ranges may be specified in the graph. According to the example of specifying display subject ranges, it is possible to specify a plural of display subject ranges to one set of time-series data. The rest of configuration and operation is similar to the designation receiver 1308 in the first embodiment.

The display data retrieving unit 3309 retrieves plural subsets of time-series data corresponding to the plural of display subject ranges received by the range designation receiver 3308 from the one entire set of time-series data stored in the storage 3304. Except for retrieving the plural subsets of time-series data, the configuration of the display data retrieving unit 3309 is similar to the display data retrieving unit 1309 in the first embodiment.

The second display unit 3310 displays plural subsets of time-series data retrieved by the display data retrieving unit 3309 in association with a time axis in a second display width, which is broader than the display subject range. The plural subsets of time-series data may be displayed in different graphs or windows, or overlapped each other and displayed in a single graph or window. The rest of configuration of the second display unit 3310 is similar to the second display unit 1310 in the first embodiment.

The analyzer 3311 analyzes plural sets of data retrieved by the display data retrieving unit 3309 and stores the analysis results in a recording medium temporally. It conducts any kinds of analysis, such as Wayland test, which is a chaos time-series analysis, or a multivariable analysis. Wayland test is explained in “Richard Wayland et al. ‘Recognizing Determinism in a Time Series’, Physical Review Letters, 1 Feb. 1993, Volume 70, Number 5, pp. 580-582.” What kind of process it conducts may be pre-determined or instructed with an input device. The analyzer 3311 is usually implemented with a micro processor unit, memory and other peripheral devices. Though analysis procedures conducted in the analyzer 3311 are usually implemented with software, which are stored in a recording medium, such as a read only memory, it also can be done with hardware, or a dedicated circuit.

The third display unit 3312 displays the analysis results, such as analyzed data or determination results done by the analyzer 3311. For instance, it displays graphs indicating the analysis results. The third display unit 3312 may include a display device or output to an external one. It can be implemented with a device driver for a display device or with a device driver and a display device or the like.

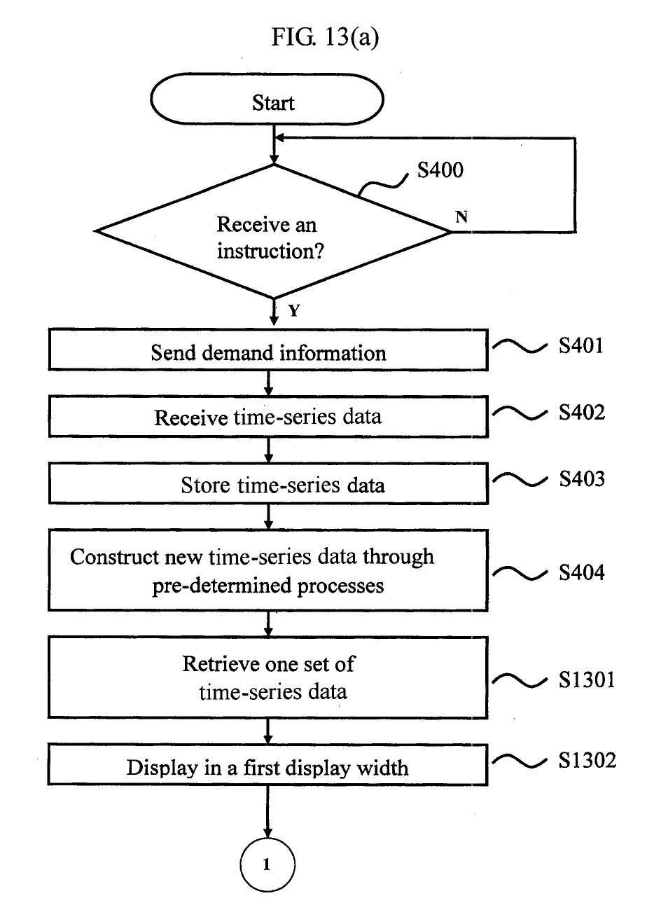

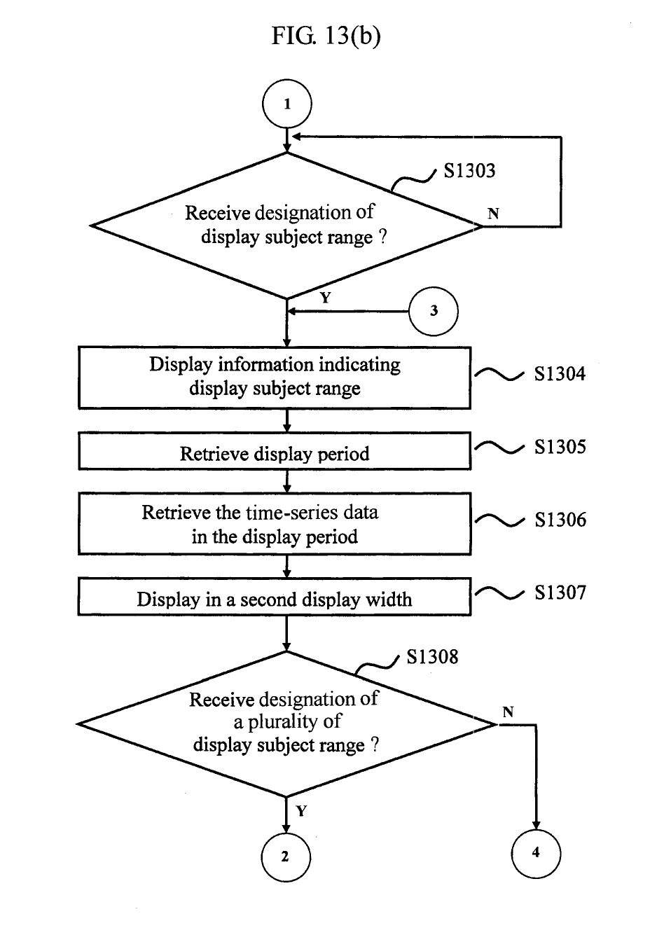

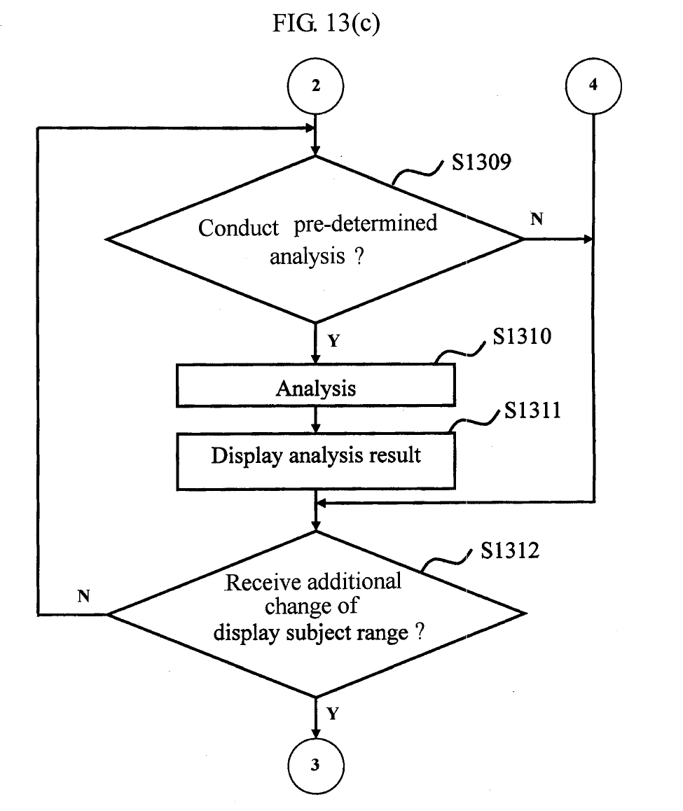

Following is an explanation of an embodiment of operation in the data display apparatus 33 with reference to the flow chart drawn in FIG. 13. The steps having numbers same with the ones in FIG. 4 are same or equivalent. The only steps different from FIG. 4 will be explained below. Especially, it will be explained an example that one display subject range is received and time-series data in a period corresponding to the range are displayed in a second display width.

(Step S1301) The data retrieving unit 3306 retrieves one set of time-series data from the storage 3304.

(Step S1302) The first display unit 3307 displays the time-series data plurally in a first display width.

(Step S1303) The range designation receiver 3308 determines whether it has received a designation of display subject range in one set of the plurally displayed data. If it has received, the process proceeds to step S1304; otherwise, returns to step S1303.

(Step S1304) The first display unit 3307 displays, or superimposes, the display subject range received in step S1303 in association with the time-series data in which the range is specified.

(Step S1305) The display data retrieving unit 3309 retrieves an actual period corresponding to the display subject range received in step S1303.

(Step S1306) The display data retrieving unit 3309 retrieves a subset of data in the display subject range from the one set of time-series data stored in the storage 3304. The subset of data is, for instance, stored in a recording medium in association with the original set of time-series data.

(Step S1307) The second display unit 3310 displays the subset of data retrieved in step S1306 in a second display width.

(Step S1308) The analyzer 3311 determines whether the range designation receiver 3308 has received plural designations of display subject ranges in the one set of time-series data. If it has received, which means ready to analyze, the process proceeds to step S1309; otherwise, returns to step S1312.

(Step S1309) The analyzer 3311 determines whether it will analyze. It can be any way how to determine whether to analyze. For instance, it is determined by instruction with an input device or by specification of display subject ranges. If it has determined to analyze, the process proceeds to step S1310; otherwise, to step S1312.

(Step S1310) The analyzer 3311 analyzes plural sets of time-series data retrieved by the display data retrieving unit 3309.

(Step S1311) The third display unit 3312 displays the analysis results of step 1310.

(Step S1312) The range designation receiver 3308 determines whether it has received a change or an addition of display subject range. If it has received, the process returns to step S1304; otherwise to step S1309.

Following is a detailed example of operation in the group management system with the data display apparatus 33 according to the present embodiment. The schematic diagram of the group management system in the present example is similar to FIG. 1.

In the present example, similar to the example explained in the first embodiment, the data receiver 1303 receives a first set of time-series data and stores it in the storage 3304.

The data retrieving unit 3306 retrieves the first measured data as one set of time-series data and stores them in the storage 3304.

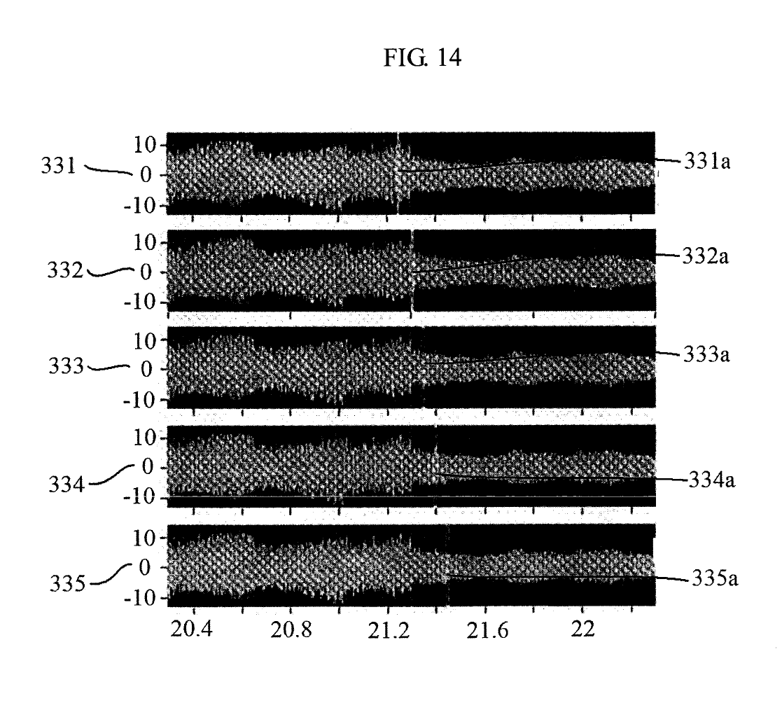

The first display unit 3307 displays the one set of time-series data plurally, for instance in five graphs whose horizontal axes are time axes, as shown in FIG. 14, on a display device. In FIG. 14, graphs 331 to 335 indicate the same time-series data.

A user moves a pointer on a display device with a mouse and chooses a range that is a part of the graph 331 displayed by the first display unit 3307. The designation receiver 3308 receives the range as a display subject range. Then, the first display unit 3307 changes the background of the region 331a, which is corresponding to the display subject range, to a color different from the other region. The display data retrieving unit 3309 retrieves a subset of data in the period corresponding to the display subject range from the original set of time-series data, and stores it temporally. The second display unit 3310 displays the subset of data in a second display width. In the present example, the subset of data is displayed in a graph next to where the display subject range is received; it is easy to see corresponding relationship between the original set and the subset. It is similar operation with examples described above, receiving the display subject range and displaying a graph having a second display width.

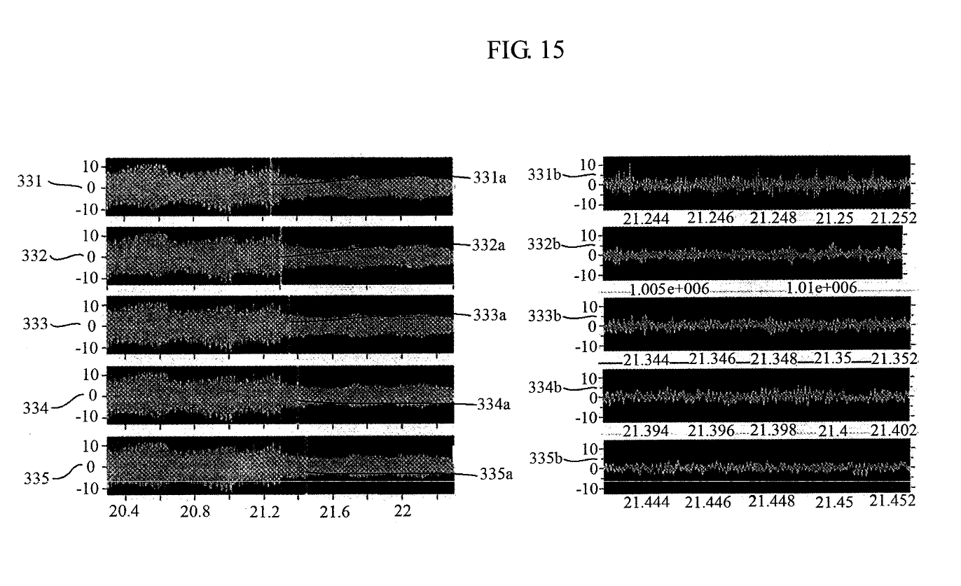

By repeating the operations described above, the range designation receiver 3308 receives display subject ranges in all of the graphs 331 to 335. The display data retrieving unit 3309 retrieves subsets of data corresponding to all of the received ranges. The second display unit 3310 displays each set of data in each of the graphs 331 to 335, as shown in FIG. 15. Each of the regions 331a to 335a corresponds to each of the ranges specified in graphs 331 to 335. The graphs 331b to 335b indicate data in the regions 331a to 335a respectively.

Displaying like above, it is easy to estimate or compare data in different regions of a single set of time-series data, which include state data or process data. Thus, it is easy to recognize an abnormal part in the set of time-series data.

At this point, the display data retrieving unit 3309 retrieves plural subsets of data from the different display subject ranges in the original set of time-series data and stores them in a recording medium.

A user instructs, for example by operating a menu screen, the analyzer 3311 to analyze the subsets of data, in the present example, with Wayland test. The analyzer 3311 retrieves the subsets of data from the recording medium, and conducts Wayland test on them. The third display unit 3312 displays the analysis result in a graph.

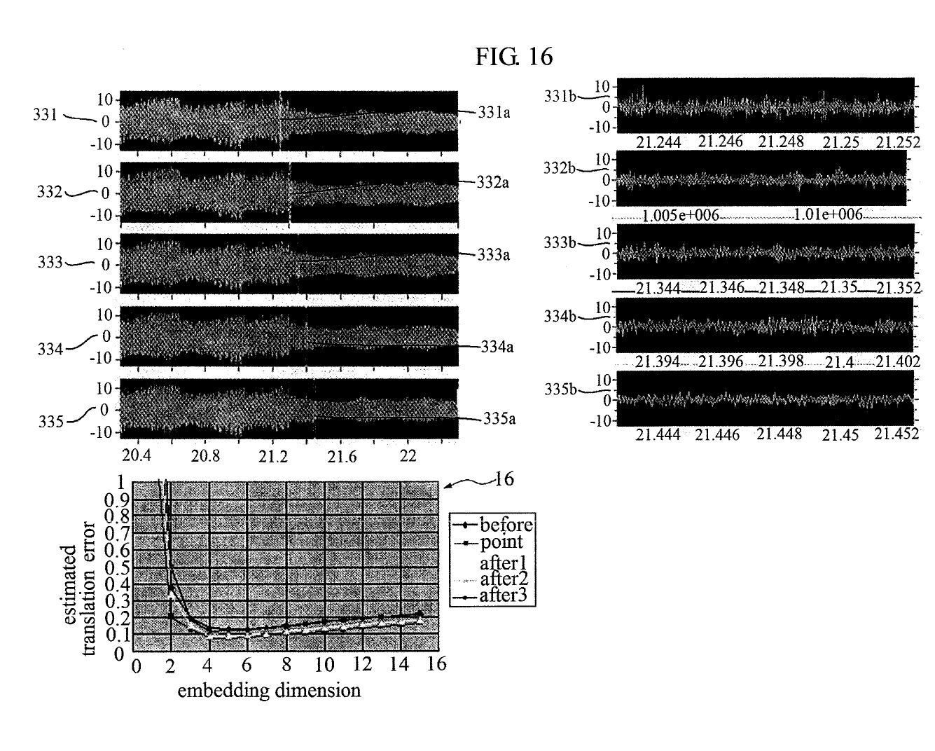

FIG. 16 shows a display example of the analysis result. In FIG. 16, graph 16 showing the result of Wayland test is added to the display example shown in FIG. 15.

Conducting Wayland test on plural subsets of data retrieved from the different display subject ranges of one set of time-series data, it is possible to obtain data indicating relationship between an embedding dimension and an estimated translation error. In a case of changing display subject range, keeping renewal of analysis result using subsets of data retrived from the changed range, it is possible to display such relationship in real-time.

Displaying an analysis result of subsets data in different regions of one set of time-series data in association with the original set of time-series data or with the different subsets of data, it is easy to compare with different data and to recognize abnormality in data.

It is similar to the detailed embodiment of the first embodiment, an operation to change display in synchronization with a change of subject range or the like.

According to the present embodiment, in addition to the first embodiment, it is possible to display subsets of data, retrieved from a plural of display subject ranges of one set of time-series data, in a second display width; it is easy to compare data within one set of time-series data and to detect abnormality effectively.

Besides, displaying an analysis result of subsets data retrieved from one set of time-series data, it is possible to detect abnormality based on combination of the analysis result and the time-series data, which include are time-series data.

The configuration in the present embodiment can be adapt to the second embodiment and have similar effects described above.

### Forth Embodiment

In yet another embodiment, a data display apparatus detects an odd-point among time-series data and receives a period during the odd-point is detected as a display subject range.

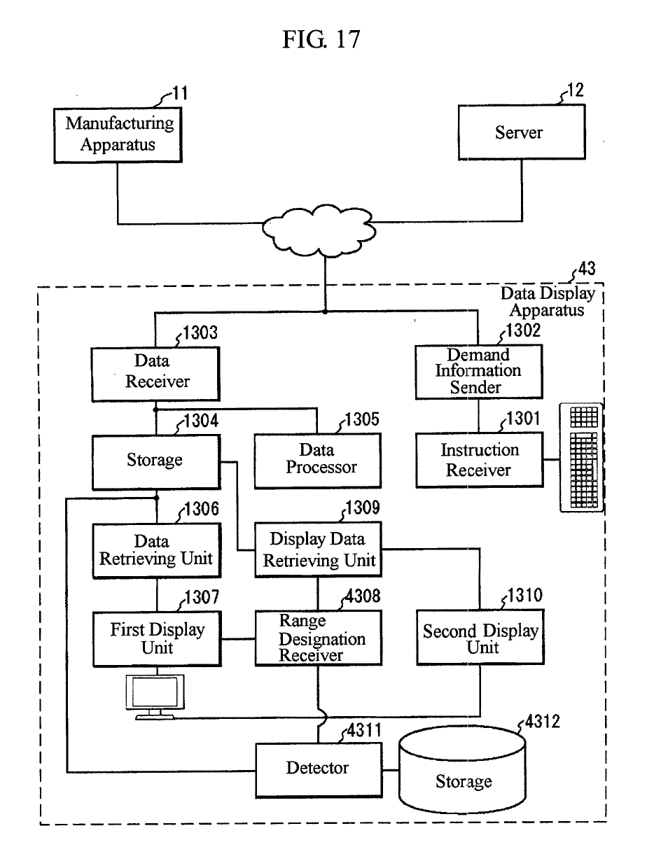

FIG. 17 is an block diagram showing an example of the group management system having a data display apparatus according to the present embodiment. The units having the numbers same with the ones in FIG. 2 are same or equivalent.

The data display apparatus 43 has a instruction receiver 1301, a demand information sender 1302, a data receiver 1303, a storage 1304, a data processor 1305, a data retrieving unit 1306, a first display unit 1307, a range designation receiver 4308, a display data retrieving unit 1309, a second display unit 1310, an detector 4311, and a pattern storage 4312.

In the data display apparatus 43, the configuration is similar to the first embodiment, except for the range designation receiver 4308, the detector 4311, and the pattern storage 4312.

The detector 4311 detects an odd-point among time-series data retrieved by the data retrieving unit 1306. An odd-point means a point having a property different from other data points, such as a point at which abnormality occurs. It is preferable in view of easiness to detect one that a set of time-series data in which an odd-point is detected are usually pre-specified. The detector 4311 can detect an odd-point in various ways. An example algorism for detection is determining a highly-correlated point as an odd-point through correlating abnormal waveform patterns, which is found and registered by a user beforehand, with time-series data. The highly-correlated point can be detected with a cross-correlation function, which is publicly known. In another case where normality is determined by whether time-series data are within a certain range, an odd-point is detected through comparing time-series data with a threshold value. The detector 4311 may detect an odd-point among time-series data stored in the storage 1304 or retrieved by the data retrieving unit 1306. The detector 4311 retrieves a period where the odd-point occurs, and outputs it to the range designation receiver 4308. The period may include just the period where the odd-point is detected or the period around when the odd-point is detected. In one example that an odd-point is detected through correlating between time-series data and registered waveform pattern as described above, the period may be where high correlation is detected between them. The period also may be obtained by adding some period before and/or after when the odd-point is detected. The period can be represented in any kinds of formats: start and end times, a start time and a length of period, a mid time and a length of period, or the like. Here, it is explained as one example that an odd-point is detected by correlating with pre-registered waveform pattern. The waveform pattern is stored in the pattern storage 4312, which will be described later. The detector 4311 is usually implemented with a micro processor unit, memory and other peripheral devices. Though detection procedures in the detector 4311 are usually implemented with software, which are stored in recording medium, such as a read only memory, it also can be done with hardware, or a dedicated circuit.

The pattern storage 4312 stores one or more waveform patterns used by the detector 4311 to detect an odd-point. The pattern storage 4312 may be either a volatile or non-volatile recording medium.

The range designation receiver 4308 receives the period of odd-point detected by the detector 4311. The configuration of the range designation receiver 4308 is similar to the explanation in the first embodiment, except for receiving a period of odd-point as display subject range.

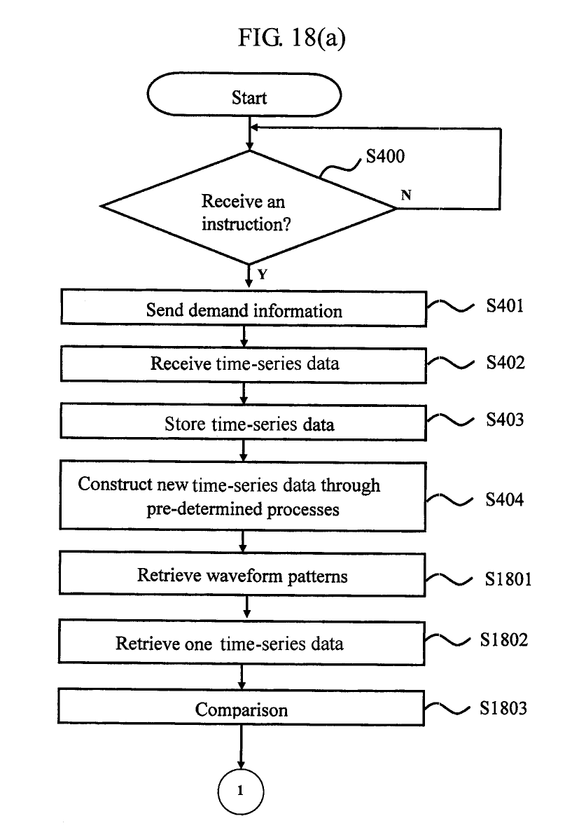

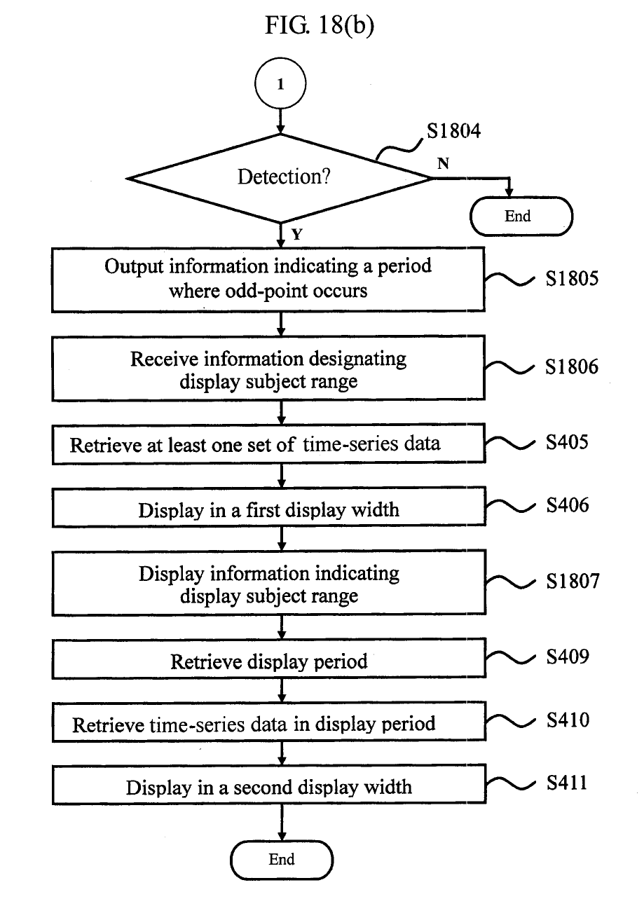

Following is an explanation of operation in the data display apparatus 43 according to the present embodiment with reference to the flow chart drawn in FIG. 18. The steps having the numbers same with the one in FIG. 4 are same or equivalent. The only steps different from FIG. 4 will be explained below.

(Step S1801) The detector 4311 retrieves a waveform pattern stored in the pattern storage 4312.

(Step S1802) The detector 4311 retrieves one set of time-series data pre-specified among different sets stored in the storage 1304.

(Step S1803) The detector 4311 calculates a correlation between the time-series data and the waveform pattern, for instance, using a cross correlation function.

(Step S1804) The detector 4311 determines whether data having high correlation with the waveform pattern in step S1803 is detected. For instance, it determines whether the correlation value calculated in step 1803 is equal to or more than a threshold value. if so, it determines that the correlation is high. If it detects highly-correlated data, or an odd-point, the process proceeds to step S1805; otherwise, ends.

(Step S1805) The detector 4311 outputs the period where the odd-point occurs. The period may be either an exact period where the odd-points are detected, or a period around when the odd-point is detected. The period is, for instance, either a period where the high correlation is detected in step S1804, or a period where pre-determined time is added therearound. The detector 4311 may also output as a period of an odd-point.

(Step S1806) The range designation receiver 4308 receives the period detected by the detector 4311, or the center time thereof and a pre-determined length of time, as a display subject range. Then, the process proceeds to S405.

(Step S1807) The first display unit 4307 displays, or superimposed, the display subject range received in step S1806 in association with the time-series data. Then, the process proceeds to step S409.

Though the flow-chart of FIG. 18 shows that the process finishes after step S411, the process may return to step S1803 to process data after detection of an odd-point in response to a user's instruction. This makes it possible to detect abnormality thereafter.

Following is a detailed example of operation the group management system according to the present embodiment. The schematic diagram of the present example of the group management system is similar to FIG. 1.

In the present example, the data receiver 1303, similar to the first embodiment, receives a first and second sets of measured data, or time-series data, and stores them into the storage 1304. Additionally, the data receiver 1303 receives a third set of measured data and stores it into the storage 1304. In the present example, the third set of measured data is of category different from but measured concurrently with the first and second ones.

Besides, the data processor 1305 wavelet-transforms the first and second sets of measured data and stores the results of transform into the storage 1304.

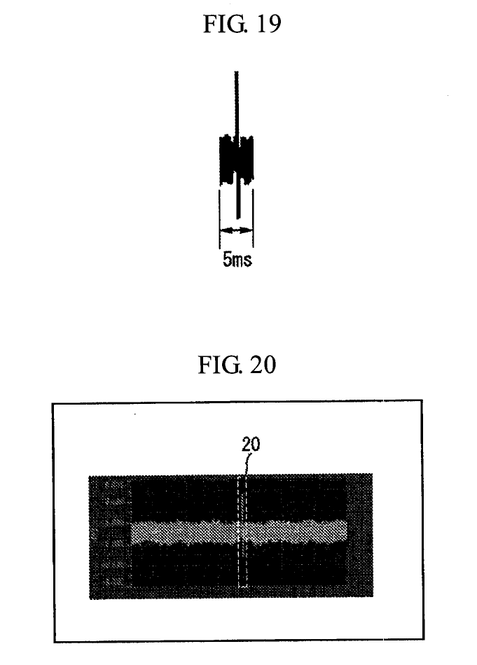

FIG. 19 shows an example of waveform pattern used to detect an odd-point, stored in the pattern storage 4312. This pattern is a waveform representing data measured before in a pre-determined time period around when abnormality is detected in measured data belonging to the same category to the third set of measured data. In the present example, the waveform represents data in 5 milliseconds. Following is an explanation of an example that, using the waveform pattern, the detector 4311 detects an odd-point showing where it can be determined that abnormality occurs in the third set of measured data.

Firstly, the detector 4311 retrieves a waveform pattern stored in the pattern storage 4312.

Secondly, the detector 4311 retrieves the third set of data from the storage 1304 and memorizes it temporarily in a memory, a buffer or the like.

The detector 4311 calculates a correlation between the third set of data and the waveform pattern. To calculate the correlation, there can be used many kinds of ways publicly known.

FIG. 20 shows an example of graph of the third set of measured data. The area 20 is where the detector 4311 determined the third set of measured data is highly correlated with the waveform pattern shown in FIG. 19 through comparison.

When the detector 4311 detects a high correlation between the waveform pattern and some period of the third measured data, it obtains the period from time stamps associated to the third measured data. The detector 4311 detects, for instance, the start and end times of pre-determined length, here is 60 milliseconds, around the obtained period. The detector 4311 sends those times to the range designation receiver 4308. In the present example, the start and end times are 1270 and 1330 milliseconds respectively.

The range designation receiver 4308 receives the start and end times detected by the detector 4311.

The data retrieving unit 1306 retrieves, similar to the first embodiment, the first and second sets of measured data from the storage 1304. The first display unit 1307 displays a first width graph where those data are overlapped each other along with a time axis. In the graph, the display subject range is displayed with a background color different from other area.

The display data retrieving unit 1309 retrieves data in the display subject range of the first and second data and the wavelet-transformed data thereof respectively. In other words, it retrieves those data from 1270 to 1330 milliseconds. The second display unit 1310 displays those data in different graphs.

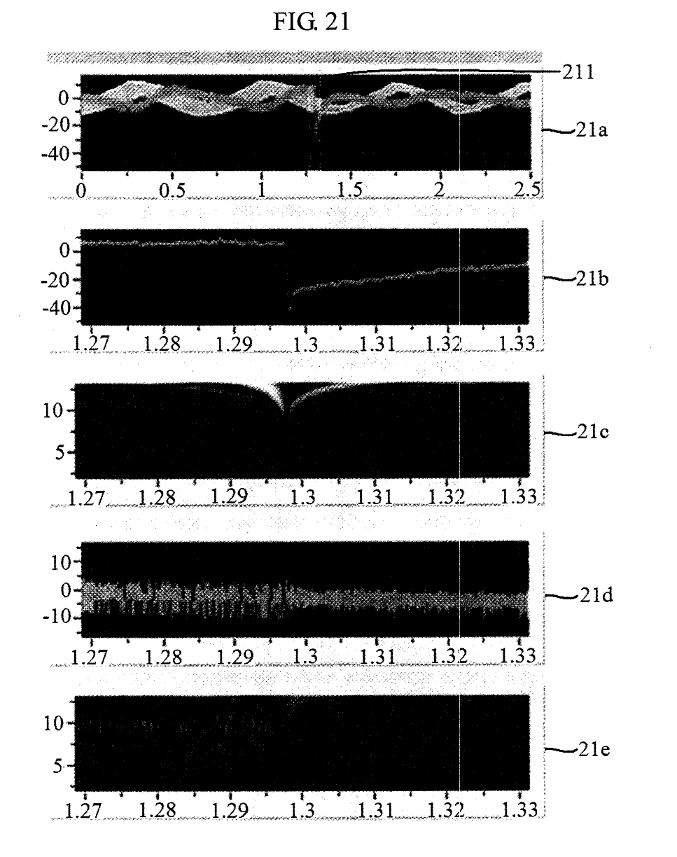

FIG. 21 shows an display example of graphs, which the first display unit 1307 and the second display unit 1310 display on a monitor. Graph 21a indicates the overlapped first and second measured data, which are displayed by the first display unit 1307. The area 211 shows the display subject range. Graphs 21b to 21e are displayed by the second display unit 1310. Graphs 21b, 21c indicate a subset of data in the display subject range of the first measured data and the wavelet-transform data thereof respectively. Graphs 21d, 21e indicate a subset of data in the display subject range of the second measured data and the wavelet-transform data thereof respectively.

In the present example, it is possible to detect automatically, from the third data, the time period where abnormality occurs, and to zoom the first and second measured data therein. Because a user needs neither to search a point where abnormality occurs nor to specify it as a display subject range, a user's burden can be reduced. Besides, because it can prevent to miss finding an abnormal point during a user's searching, reliability of data analysis can be increased.

According to the present embodiment, in addition to the effect of the first embodiment, there are several effect: A display subject range can be obtained automatically by detecting an odd-point from one set of various measured data, or time-series data, and using a period where the odd-points detected as a display subject range; A user's burden can be reduced by obtaining the range automatically; And reliability of data analysis can be increased because it can prevent to miss finding an abnormal point during manual searching, by detecting the odd-point, which is appropriate to be displayed in a second display width.

The configuration in the present embodiment can be adapted to the second and third embodiments and have similar effects described above.

In the embodiments described above, each process or function can be implemented by either one integrated unit or system, or different units or systems.

In the embodiments described above, each element can be implemented by dedicated hardware, or software if possible. For instance, each element is implemented by that a program execution unit, such as a CPU, retrieves and executes a software program stored in a recoding medium, such as a hard disk or a semiconductor memory.

Software that implements data display apparatus in the embodiment described above are a program, which performs a method that includes retrieving at least one set of time-series data related to conditions during processing semiconductor from a storage and displaying the time-series data in a first display width in association with a time axis. A designation of at least one display subject range is retrieved, which includes at least a part of the time-series data displayed by said first display unit. The at least one display subject range is displayed in association with the time-series data. Subset data are retrieved from each set of the time-series data during a period corresponding to the display subject range. The subset data are displayed in a second display width, which is wider than that of the display subject range, in association with a time axis.

Needless to say but the program described above does not include functions that can be implemented only by hardware. Such functions are, for instance, a loading unit for obtaining data or a input/output unit for inputting/outputting data, such as a modem or interface card.

The program can be download, for execution, from either an external device, such as a server, or an recording medium, such as an optical disk, a magnetic disk or a semiconductor memory.

The computer that executes the program can be either single or plural. In other words, the program can be executed in either integrated or distributed processing.

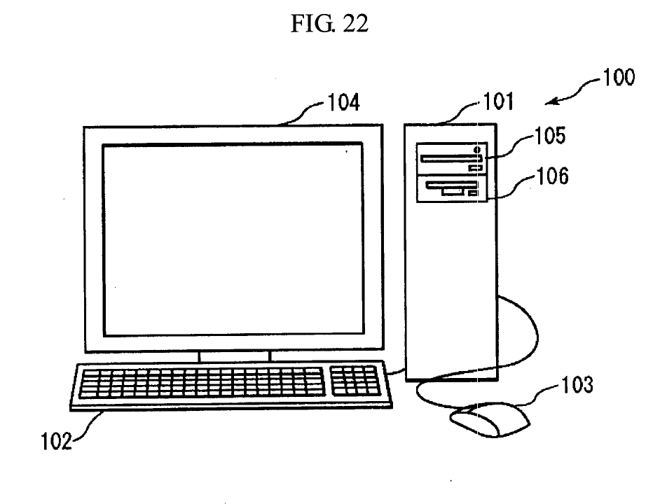

FIG. 22 is an appearance diagram of an example of a computer system that executes the program and implements data display apparatus in the above embodiments. The embodiments are implemented by computer hardware and a computer program executed thereon.

In FIG. 22, the computer system 100 has a computer 101 having a CD-ROM (Compact Disk Read Only Memory) drive 105 and a floppy disk drive 106, a keyboard 102, a mouse 103, a monitor 104.

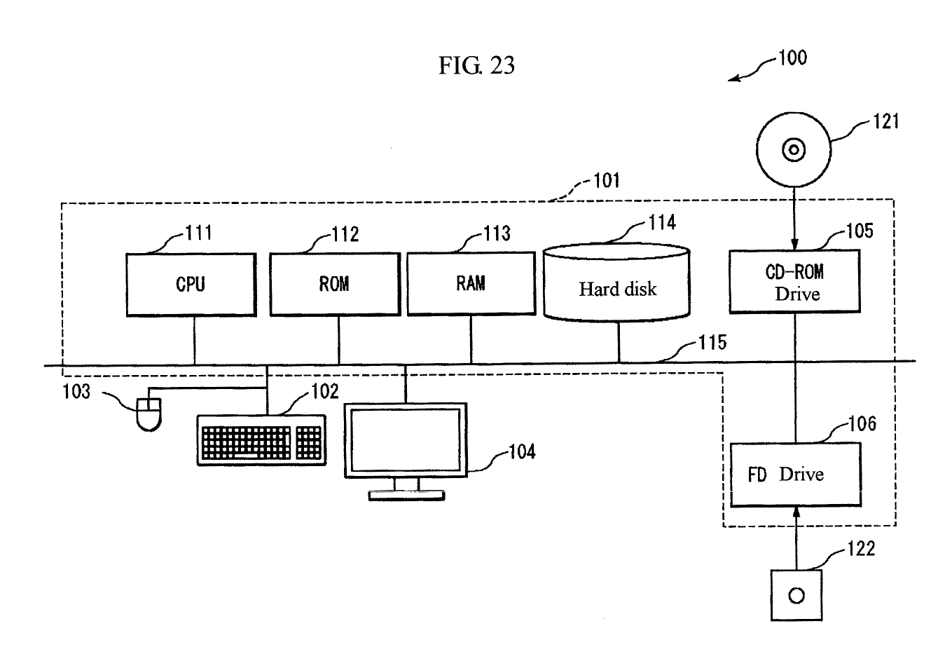

FIG. 23 is a block diagram of the computer system 100. In FIG. 23, the computer system 100 has, in addition to the CD-ROM drive 105 and the floppy disk drive 106, CPU (Central Processing Unit) 111, ROM (Read Only Memory) 112 for storing a boot-up program or the like, RAM (Random Access Memory) 113 connected to CPU for storing temporally instructions of application programs or other data, a hard disk 114 for storing application programs, a system programs and data, a bus 115 for connecting the CPU 111, the ROM or other components each other. The computer 101 may also have components not illustrated in FIG. 23, such as a network card for connecting to LAN.

A program making the computer system 100 carry out functions of the data display apparatus in the above embodiments may also be stored in the CD-ROM 121 or Floppy Disk 122, which are inserted into the CD-ROM drive 105 or FD drive 106 for transferring the program to the hard disk 114. The program can be sent via a network and stored in the hard disk 114, instead. The program in the hard disk 114 is loaded into the RAM 113 at execution. The program may also load into the RAM 113 directly from the CD-ROM 121, the floppy disk 122 or the network.

The program may not include entire functions, such as operating system or a third party program, to make the computer 101 work as a data display apparatus in the above embodiments. The program may have instructions to call appropriate functions, or modules, in controlled manner to carry out desired operations.

In the above embodiments, a plural of communication units, such as a demand information sender and a data receiver, in one apparatus can be implemented in physically single device.

As mentioned above, the data display apparatus according to the embodiments of the present invention is applicable to a data display apparatus for displaying plural sets of time-series data, which include state data or process data and are measured in or related to a semiconductor process. In particular, it is useful as a data display apparatus for displaying a plural sets of time-series data on graphs arrayed in parallel.

Obviously, numerous modifications and variations of the present invention are possible in light of the above teachings. It is therefore to be understood that within the scope of the appended claims, the invention may be practiced otherwise than as specifically described herein.

1. A data display apparatus comprising:
a storage configured to store time-series data related to conditions during processing semiconductor;
a data retrieving unit configured to retrieve at least one set of the time-series data from said storage;
a first display unit configured to display the time-series data in a first display width in association with a time axis;
a designation receiver configured to receive a designation of at least one display subject range, which includes at least a part of the time-series data;
a display data retrieving unit configured to retrieve subset data from the at least one set of the time-series data during at least one period corresponding to the at least one display subject range; and
a second display unit configured to display the subset data in a second display width, which is wider than that of the display subject range, in association with a time axis;
wherein said first display unit also displays the at least one display subject range in association with the time-series data.

2. The data display apparatus according to claim 1,
wherein said data retrieving unit retrieves a plural set of time-series data,
wherein said designation receiver receives a designation of a display subject ranges, and
wherein said display data retrieving unit is configured to retrieve subset data from each set of the time-series data during a period corresponding to the display subject range.

3. The data display apparatus according to claim 1,
wherein said data retrieving unit retrieves one set of time-series data,
wherein said designation receiver receives a designation of a plural of display subject ranges, and
wherein said display data retrieving unit configured to retrieve a plural subsets of data from the one set of time-series data during periods corresponding to the display subject ranges.

4. The data display apparatus according to claim 3,
wherein said first display unit displays the one set of time-series data, retrieved by said the data retrieving unit, plurally in a first display width in associate with a time axis,
wherein said designation receiver receives one display subject range for each displayed set of time-series data, and
wherein said first display unit also displays each of the display subject ranges in associate with each displayed set of the time-series data.

5. The data display apparatus according to claim 1, further comprising:
a analyzer configured to analyze the time-series data; and
a third display unit configured to display an analysis result thereof.

6. The data display apparatus according to claim 1, further comprising:
a data processor configured to process the subset data retrieved by said display data retrieving unit,
wherein said second display unit displays the subset data and a process result thereof in a second display width, which is wider than the display subject range, in associate with a time axis.

7. The data display apparatus according to claim 1,
wherein said designation receiver receives a display subject range designated by an operation on an instruction device regarding the time-series data displayed by said first display unit.

8. The data display apparatus according to claim 1,
wherein said first display unit superimposes a display subject range on the time-series data, and
wherein said designation receiver receives a display subject range in response to an operation to change location or width on an instruction device regarding the time-series data displayed by said first display unit.

9. The data display apparatus according to claim 1, further comprising:
a detector configured to detect an odd-point in the time-series data,
wherein said designation receiver receives a period where the odd-point occurs as a display subject range.

10. A data display method comprising:
retrieving at least one set of time-series data related to conditions during processing semiconductor from storage;
displaying the time-series data in a first display width in association with a time axis;
receiving a designation of at least one display subject range, which includes at least a part of the time-series data displayed in said first display width;
displaying the at least one display subject range in association with the time-series data;
retrieving subset data from each set of the time-series data during a period corresponding to the display subject range; and
displaying the subset data in a second display width, which is wider than that of the display subject range, in association with a time axis.

11. The data display method according to claim 10,
wherein a plural set of time-series data are retrieved from the storage,
wherein a designation of one display subject ranges is received, which include a part of the plural set of time-series, and
wherein subset data are retrieved from each set of the time-series data during a period corresponding to the display subject range.

12. The data display method according to claim 10,
wherein a one set of time-series data is retrieved from the storage,
wherein a designation of a plural of display subject ranges are received, and
wherein a plural subsets of data are retrieved from the one set of time-series data during periods corresponding to the display subject ranges.

13. The data display method according to claim 12,
wherein the one set of time-series data is displayed plurally in a first display width in association with a time axis,
wherein one display subject range for each displayed set of time-series data is received, and
wherein each of the display subject ranges is also displayed in association with each displayed set of the time-series data.

14. The data display method according to claim 10, further comprising:
analyzing the time-series data; and
displaying an analysis result of the time-series data.

15. The data display method according to claim 10, further comprising:
processing the subset data, and
displaying a process result of the subset data in the second display width.

16. The data display method according to claim 10,
wherein the display subject range is designated by an operation on an instruction device regarding the displayed time-series data.

17. The data display method according to claim 10, further comprising:
superimposing a display subject range on the time-series data,
wherein a display subject range is designated in response to an operation to change location or width on an instruction device regarding the displayed time-series data.

18. The data display method according to claim 10, further comprising:
detecting an odd-point in the time-series data,
wherein a period where the odd-point occurs is designated as a display subject range.

19. A program configured to cause a computer to perform the method according to claim 10.

20. A data display apparatus comprising:
means for storing time-series data related to conditions during processing semiconductor;
means for retrieving at least one set of the time-series data from said storage;
means for displaying the time-series data in a first display width in association with a time axis;
means for receiving a designation of at least one display subject range, which include at least a part of the time-series data;
means for retrieving subset data from the at least one set of the time-series data during at least one period corresponding to the at least one display subject range; and
means for displaying the subset data in a second display width, which is wider than that of the display subject range, in association with a time axis.
